(19) United States
(12) Patent Application Publication
(10) Pub. No.: US 2002/0054970 A1
(43) Pub. Date: May 9, 2002

(54) Shoe outsole

(76) Inventor: Ikuko Umezawa, Kobe-shi (JP)

Correspondence Address: BIRCH STEWART KOLASCH & BIRCH, PO BOX 747, FALLS CHURCH, VA, 22040-0747, US

(21) Appl. No.: 09/923,408

(22) Filed: Aug. 8, 2001

(30) Foreign Application Priority Data
Sep. 8, 2000 (JP) 2000-272762

(51) Int. Cl. B32B 1/02

(52) U.S. Cl. 428/36.8

(57) ABSTRACT

An outsole (1) comprises a projection (2) provided on a bottom face. A portion of the bottom face other than the projection (2) is a concave portion (3). The outsole (1) is molded by crosslinking a rubber composition. A base polymer of the rubber composition contains 30% by weight or more of an acrylonitrile-butadiene rubber having a glass transition point of −40° C. to 0° C. A loss factor curve of the outsole (1) has a peak temperature of −30 ° C. to 0° C. The peak temperature of the loss factor curve is measured by means of a viscoelasticity spectrometer. The measurement is carried out on such a condition that an initial strain is 10%, an amplitude is ±2%, a frequency is 10 Hz, a starting temperature is −100° C., an ending temperature is 100° C., a temperature rising speed is 3° C./min and a deformation mode is a tension.

### BACKGROUND OF THE INVENTION

1. Field of the Invention

The present invention relates to shoes such as walking shoes or trekking shoes, and outsoles to be used for the shoes.

2. Description of the Related Art

A shoe has an outsole forming a bottom face thereof. The outsole is usually formed of a polymer composition having a rubber or the like as a base material. Important demand performance for the outsole includes difficulty of slipping out of a ground, that is, a good slip prevention performance. In order to enhance the slip prevention performance, the outsole has conventionally been devised variously. For example, Japanese Patent No. 2957480 has disclosed an outsole having the slip prevention performance enhanced through the use of a specific solution polymerized styrene-butadiene rubber.

However, an outsole having a sufficient slip prevention performance cannot be obtained under the actual circumstances. A water film is provided between the outsole and the ground in the rain or at the waterside. In some cases, the water film promotes a slip between the ground and the outsole. It has been desirable that an outsole having an excellent slip prevention performance on the wet ground should be developed.

In consideration of such circumstances, it is an object of the present invention to provide an outsole for displaying a sufficient slip prevention performance on the wet ground and shoes comprising the outsoles.

### SUMMARY OF THE INVENTION

The present invention provides an outsole which is molded by crosslinking a rubber composition. A peak temperature of a loss factor curve of the outsole is −30° C. to 0° C. The peak temperature of the loss factor curve is measured by a viscoelasticity spectrometer. The measurement is carried out on such a condition that an initial strain is 10%, an amplitude is ±2%, a frequency is 10 Hz, a starting temperature is −100° C., an ending temperature is 100° C., a temperature rising speed is 3° C./min, and a deformation mode is a tension. A base polymer of the rubber composition contains 30% by weight or more of an acrylonitrile-butadiene rubber having a glass transition point of −40° C. to 0° C.

The acrylonitrile-butadiene rubber (NBR) has a high oil resistance and is used for the requirement of the oil resistance (a sole of a safety shoe). In the outsole according to the present invention, an acrylonitrile-butadiene rubber having a glass transition point within a predetermined range is selectively used, and furthermore, a peak temperature of a loss factor is set within a predetermined range. Accordingly, the outsole displays a much more excellent slip prevention performance than a conventional outsole. In particular, the outsole has a more excellent slip prevention performance (which will be hereinafter referred to as a “wet grip performance”) on the wet ground than a conventional outsole containing a styrene-butadiene rubber (SBR) and a butadiene rubber (BR) as principal components. A shoe using the outsole causes a slip with difficulty.

It is preferable that a complex elastic modulus (E*) of the outsole at −10° C. which is measured on the above-mentioned conditions should be 15.0 MPa or more. Consequently, the outsole displays a more excellent wet grip performance.

It is preferable that a loss factor (tan δ) of the outsole at −10° C. which is measured on the above-mentioned conditions should be 0.50 or more. Consequently, the outsole displays a more excellent wet grip performance.

The present invention will be described below in detail based on a preferred embodiment with reference to the drawings.

### BRIEF DESCRIPTION OF THE DRAWINGS

FIG. 1 is a bottom view showing an outsole according to an embodiment of the present invention,

FIG. 2 is a longitudinal sectional view showing a part of the outsole illustrated in FIG. 1, and

FIG. 3 is a perspective view showing a portable skid resistance tester for measuring a grip index.

### DESCRIPTION OF THE PREFERRED EMBODIMENTS

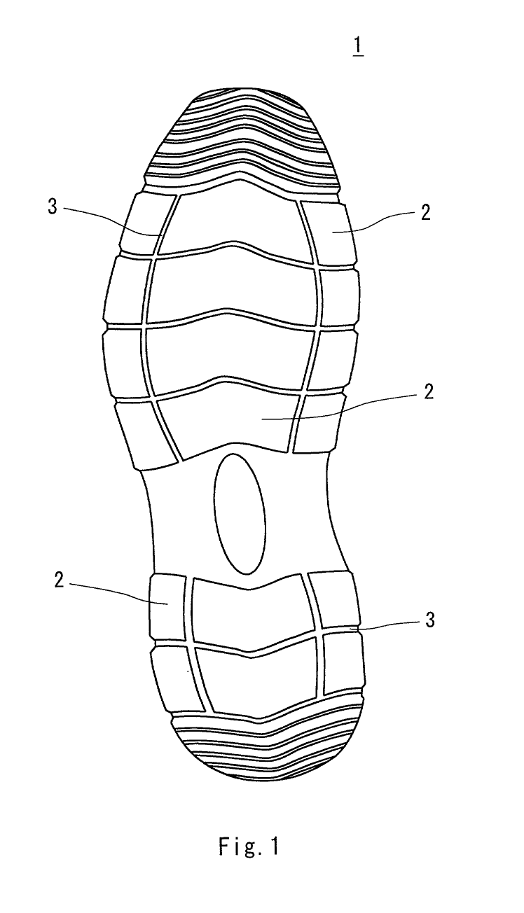

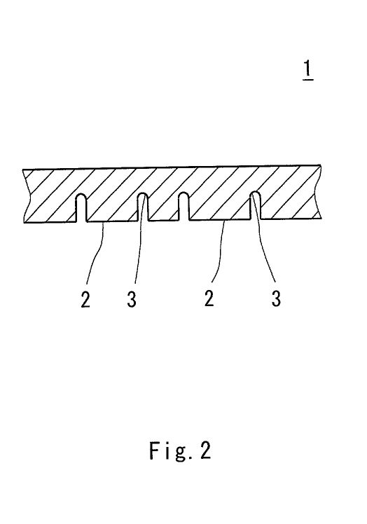

As shown in FIGS. 1 and 2, an outsole 1 comprises a projection 2 provided on a bottom face. The bottom face has a concave portion 3 other than the projection 2. FIG. 1 shows only the outsole 1 for a right foot, and the outsole 1 for a left foot has a shape obtained by transversely inverting the shape shown in FIG. 1. An upper and an insole which are well known are attached to the outsole 1, thereby constituting a shoe.

The outsole 1 is formed by crosslinking a rubber composition. A base polymer to be used for the rubber composition contains an acrylonitrile-butadiene rubber having a glass transition point (Tg) of −40° C. to 0° C. If the glass transition point of the acrylonitrile-butadiene rubber is less than −40° C., the outsole 1 has an insufficient wet grip performance in some cases. From this viewpoint, it is preferable that an acrylonitrile-butadiene rubber having a glass transition point of −35° C. or more, particularly, −32° C. or more should be used. If the glass transition point of the acrylonitrile-butadiene rubber is more than 0° C., a crack is sometimes generated on the outsole 1 when the outsole 1 is used at a low temperature. From this viewpoint, it is preferable that an acrylonitrile-butadiene rubber having a glass transition point of −5° C. or less, particularly, −8° C. or less should be used.

In the case in which an acrylonitrile-butadiene rubber having a glass transition point of −40° C. to 0° C. is used together with another base polymer, the acrylonitrile-butadiene rubber having a glass transition point of −40° C. to 0° C. occupies a ratio of 30% by weight or more of the whole polymer. Consequently, the wet grip performance of the outsole 1 is improved. From this viewpoint, it is preferable that the ratio should be 50% by weight or more, particularly, 70% by weight or more. In respect of the wet grip performance, it is the most preferable that the ratio should be 100% by weight. The acrylonitrile-butadiene rubber is generally expensive. In respect of a reduction in the cost of a material, therefore, another polymer may be used together. Moreover, other polymers may be used together in order to enhance a strength, an abrasion resistance and a workability.

Examples of a rubber to be used together include a natural rubber, another acrylonitrile-butadiene rubber, a styrene - butadiene rubber, a butadiene rubber, an isoprene rubber, a butyl rubber, a chloroprene rubber, an ethylene - propylene - diene rubber, an acryl rubber, an epichlorohidrin rubber, a polysulfide rubber, an urethane rubber and the like. Moreover, a synthetic resin or a thermoplastic elastomer may be used together.

It is preferable that an acrylonitrile-butadiene rubber having a bound acrylonitrile ratio (AN ratio) of 25% or more, furthermore 28% or more, and particularly 31% or more should be used. If the bound acrylonitrile ratio is less than the above-mentioned range, the wet grip performance of the outsole 1 becomes insufficient in some cases. It is hard to inexpensively acquire an acrylonitrile-butadiene rubber having an extremely high bound acrylonitrile ratio. Therefore, it is preferable that the bound acrylonitrile ratio should be 43% or less, furthermore 38% or less, and particularly 36% or less.

A rubber composition is crosslinked by well-known means. Usually, sulfur is used as a crosslinking agent. In general, the amount of the sulfur to be blended is 0.3 to 5.0 parts by weight, particularly, 0.5 to 3.0 parts by weight for 100 parts by weight of a base polymer. Vulcanization accelerators may be used together with the sulfur. Examples of suitable vulcanization accelerators include thiazole type vulcanization accelerators, thiuram type vulcanization accelerators, sulfenamide type vulcanization accelerators and diocarbamate type vulcanization accelerators. In particular, it is preferable that the thiazole type vulcanization accelerators and the thiuram type vulcanization accelerators should be used for the outsole 1. The amount of vulcanization accelerators to be blended is 0.5 to 7 parts by weight, particularly 1.5 to 4 parts by weight for 100 parts by weight of the base polymer. A metallic compound such as zinc oxide or fatty acid such as stearic acid may be blended as activator.

In order to enhance a strength, it is preferable that a filler should be blended with a rubber composition. Examples of the filler to be used include silica, carbon black, calcium carbonate and clay. In particular, the silica and the carbon black which have an excellent reinforcing effect are preferably used, and the silica having a primary particle size of 30 nm or less is used more preferably. The amount of the silica to be blended is generally 3 to 70 parts by weight, particularly, 35 to 65 parts by weight for 100 parts by weight of the base polymer. A proper amount of a silanizing agent or a silane coupling agent may be blended with the silica. Consequently, the water repellency of the outsole 1 can be enhanced. Furthermore, an additive such as a plasticizer, an antioxidant or a coloring agent may be properly blended with the rubber composition.

A temperature at which a loss factor (tan δ) curve of the outsole 1 has a peak is −30° C. to 0° C. If the peak temperature is less than −30° C., the outsole 1 has an insufficient wet grip performance in some cases. From this view point, it is preferable that the peak temperature should be −25° C. or more, particularly, −22° C. or more. If the peak temperature is more than 0° C., a crack is sometimes generated on the outsole 1 when the outsole 1 is used at a low temperature. From this viewpoint, it is preferable that the peak temperature should be −5° C. or less, particularly, −8° C. or less. The loss factor is measured by a viscoelasticity spectrometer on the conditions shown in the following Table 1.

TABLE 1
Condition of measurement in viscoelasticity spectrometer

| | |
|---|---|
| Initial strain | 10% |
| Amplitude | ±2% |
| Frequency | 10 Hz |
| Starting temperature | −100° C. |
| Ending temperature | 100° C. |
| Temperature rising speed | 3° C./min |
| Deformation mode | tension |

A test piece to be used for the measurement using the viscoelasticity spectrometer is plate-shaped, and has a length of 45 mm, a width of 4 mm and a thickness of 2 mm. Both ends of the test piece are chucked to carry out the measurement. The displaced portion of the test piece has a length of 30 mm. The test piece is cut out of the outsole 1. In the case in which the cut-out is hard to perform, a slab having a thickness of 2 mm is molded of the same rubber composition as that of the outsole 1 and is crosslinked in a mold, and the test piece is punched out of the slab. The slab is crosslinked for 10 minutes at 160° C.

It is preferable that a complex elastic modulus (E*) of the outsole 1 at −10° C. should be 15.0 MPa or more. If the complex elastic modulus is less than 15.0 MPa, the wet grip performance of the outsole 1 becomes insufficient in some cases. From this viewpoint, it is more preferable that the complex elastic modulus should be 16.0 MPa or more, particularly 17.0 MPa or more. As the complex elastic modulus is increased, the wet grip performance of the outsole 1 tends to be enhanced. The complex elastic modulus of the outsole 1 which is usually obtained is 100 MPa or less, particularly, 80 MPa or less. The complex elastic modulus at −10° C. is measured by the viscoelasticity spectrometer on the conditions shown in the Table 1.

It is preferable that a loss factor (tan δ) of the outsole 1 at −10° C. should be 0.50 or more. If the loss factor is less than 0.50, the wet grip performance of the outsole 1 becomes insufficient in some cases. From this viewpoint, it is preferable that the loss factor should be 0.55 or more, particularly 0.60 or more. As the loss factor is increased, the wet grip performance of the outsole 1 tends to be enhanced. The loss factor of the outsole 1 which is usually obtained is 3.0 or less, particularly, 2.0 or less. The loss factor at −10° C. is measured by the viscoelasticity spectrometer on the conditions shown in the Table 1.

In the manufacture of the outsole 1, first of all, a base polymer, a crosslinking agent, various additives are kneaded by means of a kneading machine such as an internal mixer or an open roll. Consequently, a rubber composition is obtained. Next, the rubber composition is put in a mold comprising a cavity having the same shape as that of the outsole 1. Then, the rubber composition is heated and pressurized to cause a crosslinking reaction. Thus, the outsole 1 is molded. It is a matter of course that another molding method such as an injection molding method may be used.

The outsole 1 is particularly suitable for shoes which are often used on the wet ground. More specifically, the outsole 1 is suitable for trekking shoes, walking shoes, golf shoes, fishing boots, diving shoes, deck shoes, shoes for a motorbike, shoes for a bathroom, rain shoes, shoes for a beach and the like.

### EXAMPLES

### Example 1

100.0 parts by weight of an acrylonitrile-butadiene rubber having a glass transition point of −28.0° C. and a bound acrylonitrile ratio of 33.5% (trade name of “Nipol DN200” produced by Nippon Zeon Co., Ltd.), 45 parts by weight of silica, (trade name of “Ultrasil VN3” produced by Degusa Co., Ltd.), 4.0 parts by weight of bis-(3-triethoxysilylpropyl)tetrasulfen (trade name of “Si 69” produced by Degusa CO., Ltd.) to be a silane coupling agent, 3.0 parts by weight of dioctylphthalate to be a plasticizer (trade name of “DOP” produced by Sanken Kako Co., Ltd.), 0.5 part by weight of an antioxidant (trade name of “Sunnoc N” produced by Ouchi Shinko Chemical Industrial Co., Ltd.) and 2.0 parts by weight of 2,6-di-tert-butyl-4-methylphenol (trade name of “Nocrac 200” produced by Ouchi Shinko Chemical Industrial Co., Ltd.) to be another antioxidant were kneaded by means of an internal mixer.

Next, the kneaded substance thus obtained was put in a roll, and furthermore, 3.0 parts by weight of zinc oxide (zinc white), 1.0 part by weight of stearic acid, 0.5 part by weight of sulfur, 1.3 parts by weight of dibenzothiazyl disulfide (trade name of “Nocceler DM” produced by Ouchi Shinko Chemical Industrial Co., Ltd.) to be vulcanization accelerators, and 2.3 parts by weight of tetrakis (2-ethylhexyl) thiuram disulfide (trade name of “Nocceler TOT-N” produced by Ouchi Shinko Chemical Industrial Co., Ltd.) to be other vulcanization accelerators were added thereto and were kneaded. Thus, a rubber composition was obtained. The rubber composition was put in a mold and was heated and pressurized for 10 minutes at a temperature of 160° C. Thus, an outsole according to an example 1 was obtained.

### Examples 2 and 3 and Comparative Example 1

Outsoles according to examples 2 and 3 and a comparative example 1 were obtained in the same manner as the example 1 except that the amount of an acrylonitrile-butadiene rubber (the above-mentioned “Nipol DN200”) to be blended was varied and a butadiene rubber having a glass transition point of −110° C. (“trade name of “BR11” produced by JSR Corporation.) was blended as shown in the following Table 2.

### Comparative Example 2

An outsole according to a comparative example 2 was obtained in the same manner as the example 1 except that an acrylonitrile-butadiene rubber having a glass transition point of −51.7° C. and a bound acrylonitrile ratio of 18.0% (trade name of “Nipol DN401” produced by Nippon Zeon Co., Ltd.) was used in place of the above-mentioned “Nipol DN200”.

### Example 4

An outsole according to an example 4 was obtained in the same manner as the example 1 except that an acrylonitrile-butadiene rubber having a glass transition point of −37.0° C. and a bound acrylonitrile ratio of 29.0% (trade name of “Nipol 1043” produced by Nippon Zeon Co., Ltd.) was used in place of the above-mentioned “Nipol DN200”.

### Example 5

An outsole according to an example 5 was obtained in the same manner as the example 1 except that an acrylonitrile-butadiene rubber having a glass transition point of −16.5° C. and a bound acrylonitrile ratio of 40.5% (trade name of “Nipol 1041” produced by Nippon Zeon Co., Ltd.) was used in place of the above-mentioned “Nipol DN200”.

### Comparative Example 3

70.0 parts by weight of a styrene-butadiene rubber having a glass transition point of −25.0° C. (trade name of “Nipol NS116” produced by Nippon Zeon Co., Ltd.), 30 parts by weight of a butadiene rubber (the above-mentioned “BR11”), 50parts by weight of silica (the above-mentioned “Ultrasil VN3”), 5.0 parts by weight of a silane coupling agent (the above-mentioned “Si69”), 5.0 parts by weight of a plasticizer (trade name of “PW380” produced by Idemitsu Kosan Co., Ltd.) and 2.0 parts by weight of an antioxidant (the above-mentioned “Nocrac200”) were kneaded by means of an internal mixer.

Next, the kneaded substance thus obtained was put in a roll, and furthermore, 3.0 parts by weight of zinc oxide (zinc white), 1.0 part by weight of stearic acid, 2.0 parts by weight of sulfur, and 1.0 part by weight of N-tert-butyl-2-benzothiazolyl sulfenamide (trade name of “Nocceler NS” produced by Ouchi Shinko Chemical Industrial Co., Ltd.) to be vulcanization accelerators were added thereto and were kneaded. Thus, a rubber composition was obtained. The rubber composition was put in a mold and was heated and pressurized for 10 minutes at a temperature of 160° C. Thus, an outsole according to a comparative example 3 was obtained.

### Comparative Example 4

75 parts by weight of a solution polymerized styrene-butadiene rubber having a peak temperature of a loss factor of −25° C. obtained when vulcanization is carried out with sulfur, 25 parts by weight of a butadiene rubber (the above-mentioned “BR11”), 60 parts by weight of hydrated silica (trade name of “Nipseal VN3” produced by Nippon Silica Co., Ltd.), 6.0 parts by weight of a silane coupling agent (the above-mentioned “Si69”), 5.0 parts by weight of a plasticizer (the above-mentioned “PW380”) and 2.0 parts by weight of an antioxidant (the above-mentioned “Nocrac 200”) were kneaded by means of an internal mixer.

Next, the kneaded substance thus obtained was put in a roll, and furthermore, 3.0 parts by weight of zinc oxide (zinc white), 1.0 part by weight of stearic acid, 2.0 parts by weight of sulfur, and 1.0 part by weight of vulcanization accelerators (the above-mentioned “Nocceler NS”) were added thereto and were kneaded. Thus, a rubber composition was obtained. The rubber composition was put in a mold and was heated and pressurized for 10 minutes at a temperature of 160° C. Thus, an outsole according to a comparative example 4 was obtained.

### Measurement of Viscoelasticity

A test piece having a length of 45 mm, a width of 4 mm and a thickness of 2 mm was cut out of the outsole according to each of the examples and the comparative examples. The test piece was subjected to viscoelasticity measurement using a viscoelasticity spectrometer (trade name of “advanced VA-200” produced by SHIMADZU CORPORATION). The conditions of the measurement are shown in the Table 1. A peak temperature of a loss factor, a complex elastic modulus at −10° C., and a loss factor at −10° C. were measured. The result is shown in the following Table 2.

### Measurement of Grip Index

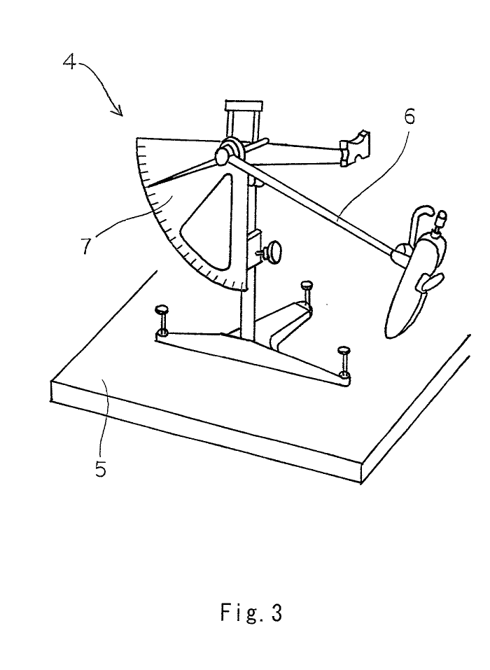

A portable skid resistance tester 4 shown in FIG. 3 was prepared and was installed on a wet substrate 5. A test piece having a length of 76 mm, a width of 25 mm and a thickness of 6 mm was cut out of each outsole and was attached to the tip of an arm 6 of the tester 4. Next, the arm 6 was lifted to have a predetermined angle and was then swung down. Thus, an angle of the highest point where the test piece was swung up after rubbing against the substrate 5 was read by means of a dial plate 7. The height of the tester 1 was regulated such that a circumferential distance at which the test piece and the substrate 5 rub against each other is 12.7 cm. A frictional resistance was calculated from an angle formed before swing-down and an angle for swing-up. The result is shown in the following Table 2. The Table 2 shows an index (grip index), wherein a frictional resistance in the comparative example 1 is 100.

TABLE 2
Result of evaluation of gripping property

| | | Example | Example | Example | Com. Ex | Com. Ex | Example | Example | Com. Ex | Com. Ex |
|---|---|---|---|---|---|---|---|---|---|---|
| | | 1 | 2 | 3 | 1 | 2 | 4 | 5 | 3 | 4 |
| N | DN401 (Tg: −51.7° C., AN: 18.0%) | — | — | — | — | 100 | — | — | — | — |
| B | 1043 (Tg: −37.0° C., AN: 29.0%) | — | — | — | — | — | 100 | — | — | — |
| R | DN200 (Tg: −28.0° C., AN: 33.5%) | 100 | 70 | 40 | 20 | — | — | — | — | — |
| | 1041 (Tg: −16.5° C., AN: 40.5%) | — | — | — | — | — | — | 100 | — | — |

| | | | | | | | | | |
|---|---|---|---|---|---|---|---|---|---|
| SBR (NS116) | — | — | — | — | — | — | — | 70 | — |
| Solution polymerized SBR | — | — | — | — | — | — | — | — | 75 |
| BR | — | 30 | 60 | 80 | — | — | — | 30 | 25 |
| Silica | 45 | 45 | 45 | 45 | 45 | 45 | 45 | 50 | — |
| Hydrated silica | — | — | — | — | — | — | — | — | 60 |
| Silane coupling agent | 4.0 | 4.0 | 4.0 | 4.0 | 4.0 | 4.0 | 4.0 | 5.0 | 6.0 |
| Plasticizer (DOP) | 3.0 | 3.0 | 3.0 | 3.0 | 3.0 | 3.0 | 3.0 | — | — |
| Plasticizer (PW380) | — | — | — | — | — | — | — | 5.0 | 5.0 |
| Antioxidant (Sunnoc N) | 0.5 | 0.5 | 0.5 | 0.5 | 0.5 | 0.5 | 0.5 | — | — |
| Antioxidant (Nocrac 200) | 2.0 | 2.0 | 2.0 | 2.0 | 2.0 | 2.0 | 2.0 | 2.0 | 2.0 |
| Zinc oxide | 3.0 | 3.0 | 3.0 | 3.0 | 3.0 | 3.0 | 3.0 | 3.0 | 3.0 |
| Stearic acid | 1.0 | 1.0 | 1.0 | 1.0 | 1.0 | 1.0 | 1.0 | 1.0 | 1.0 |
| Sulfur | 0.5 | 0.5 | 0.5 | 0.5 | 0.5 | 0.5 | 0.5 | 2.0 | 2.0 |
| Vulcanization accelerator DM | 1.3 | 1.3 | 1.3 | 1.3 | 1.3 | 1.3 | 1.3 | — | — |
| Vulcanization accelerator | 2.3 | 2.3 | 2.3 | 2.3 | 2.3 | 2.3 | 2.3 | — | — |
| TOT-N | | | | | | | | | |
| Vulcanization accelerator NS | — | — | — | — | — | — | — | 1.0 | 1.5 |
| peak temperature of tan δ (° C.) | −16 | −25 | −29 | −41 | −41 | −26 | −8 | −23 | −20 |
| E* at −10° C. (MPa) | 28.0 | 20.8 | 18.1 | 12.8 | 12.4 | 25.8 | 27.4 | 25.5 | 20.6 |
| tan δ at −10° C. | 0.86 | 0.69 | 0.53 | 0.18 | 0.22 | 0.71 | 0.81 | 0.40 | 0.46 |
| Grip index | 190 | 175 | 150 | 100 | 98 | 179 | 188 | 97 | 99 |

From the Table 2, it is apparent that the outsole according to each of the examples has a wet gripping performance which is much more excellent than that of the outsole according to each of the comparative examples. From the result of the evaluation, the advantage of the present invention is apparent.

The above description is only illustrative and can be variously changed without departing from the scope of the invention.

What is claimed is:

1. A shoe outsole formed by crosslinking a rubber composition,
wherein a peak temperature of a loss factor curve measured by a viscoelasticity spectrometer is −30° C. to 0° C. on such a condition that an initial strain is 10%, an amplitude is ±2%, a frequency is 10 Hz, a starting temperature is −100° C., an ending temperature is 100° C., a temperature rising speed is 3° C./min and a deformation mode is a tension, and
a base polymer of the rubber composition contains 30% by weight or more of an acrylonitrile-butadiene rubber having a glass transition point of −40° C. to 0° C.

2. The shoe outsole according to claim 1, wherein a complex elastic modulus at −10° C. which is measured by means of the viscoelasticity spectrometer is 15.0 MPa or more on such a condition that an initial strain is 10%, an amplitude is ±2%, a frequency is 10 Hz, a starting temperature is −100° C., an ending temperature is 100° C., a temperature rising speed is 3° C./min and a deformation mode is a tension.

3. The shoe outsole according to claim 1, wherein a loss factor at −10° C. which is measured by means of the viscoelasticity spectrometer is 0.50 or more on such a condition that an initial strain is 10%, an amplitude is ±2%, a frequency is 10 Hz, a starting temperature is −100° C., an ending temperature is 100° C., a temperature rising speed is 3° C./min and a deformation mode is a tension.

4. A shoe comprising an outsole formed by crosslinking a rubber composition,
wherein a peak temperature of a loss factor curve measured by a viscoelasticity spectrometer is −30° C. to 0° C. on such a condition that an initial strain is 10%, an amplitude is ±2%, a frequency is 10 Hz, a starting temperature is −100° C., an ending temperature is 100° C., a temperature rising speed is 3° C./min and a deformation mode is a tension in the outsole, and
a base polymer of the rubber composition contains 30% by weight or more of an acrylonitrile-butadiene rubber having a glass transition point of −40° C. to 0° C.
